(19) United States
(12) Patent Application Publication
(10) Pub. No.: US 2026/0106051 A1
(43) Pub. Date: Apr. 16, 2026

(54) WIRE HARNESS

(71) Applicant: Proterial, Ltd., Tokyo (JP)

(72) Inventors: Hiroshi YAMADA, Tokyo (JP); Tomoaki SUZUKI, Tokyo (JP)

(21) Appl. No.: 19/349,280

(22) Filed: Oct. 3, 2025

(30) Foreign Application Priority Data
Oct. 11, 2024 (JP) 2024-179353

(51) Int. Cl. H01B 7/00; B60R 16/02; G01M 17/013; G01P 3/44

(52) U.S. Cl. CPC H01B 7/0045; B60R 16/0215; G01M 17/013; G01P 3/44

(57) ABSTRACT

A wire harness, includes a plurality of cables, a sheath collectively covering a portion in a longitudinal direction of the plurality of cables, a resin molded member integrally having a sheath holding portion covering an outer periphery of an end of the sheath from which the plurality of cables are led out and holding the sheath, and a cable holding portion holding the plurality of cables led out from the sheath, and a mounting member mounted on the resin molded member, wherein the mounting member has a holding portion for holding at least one cable of the plurality of cables and guides the at least one cable in a direction different from that of other cables.

### CROSS-REFERENCE TO RELATED APPLICATIONS

The present application is based on Japanese patent application No. 2024-179353 filed on October 11, 2024, the entire contents of which are incorporated herein by reference.

### TECHNICAL FIELD

The present invention relates to a wire harness having multiple cables.

### BACKGROUND OF THE INVENTION

Conventionally, vehicles, for example, have wire harnesses with multiple cables installed to connect in-vehicle (on-board) devices such as wheel speed sensors and electric parking brakes, which are positioned under the springs (i.e., unsprung devices), to the control unit on the vehicle body side. The Applicant has proposed wire harnesses as described in Patent Literatures 1 to 4 for such purposes. In these wire harnesses, one cable among the multiple cables is connected to the wheel speed sensor, while the other cables are connected to devices such as the electric parking brake device or the electronically controlled active damper device. A portion of the longitudinal direction of these cables is covered by a tubular sheath, and the cables are led out from a sheath inside a resin molded member provided at the end of the sheath. Furthermore, each cable is led out from the resin molded member in various directions toward its respective connection target (e.g., wheel speed sensor, electric parking brake device, active damper device, etc.). The resin molded member is fixed to the vehicle body side by a metal bracket.

Citation List Patent Literature 1: JP2022-31329A

Patent Literature 2 JP2021-44127A

Patent Literature 3 JP2020-161311A

Patent Literature 4 JP2020-47517A

### SUMMARY OF THE INVENTION

The in-vehicle devices to which multiple cables of a wire harness connect, and their arrangement, vary depending on the vehicle configuration. Similarly, the direction in which each cable led out from the resin molded member also varies considerably depending on the vehicle configuration. Consequently, the shape of the resin molded member differs for each vehicle model, necessitating the preparation of a wide variety of molds to form the resin molded member, which has hindered the reduction of manufacturing costs.

Therefore, an object of the present invention is to provide a wire harness that can suppress the increase in mold costs and thereby reduce manufacturing costs, even when the connection targets and arrangement of multiple cables vary significantly.

So as to solve the above problem, one aspect of the present invention is to provide a wire harness, comprising:

a plurality of cables;

a sheath collectively covering a portion in a longitudinal direction of the plurality of cables;

a resin molded member integrally having a sheath holding portion covering an outer periphery of an end of the sheath from which the plurality of cables are led out and holding the sheath, and a cable holding portion holding the plurality of cables led out from the sheath; and

a mounting member mounted on the resin molded member,

wherein the mounting member has a holding portion for holding at least one cable of the plurality of cables and guides the at least one cable in a direction different from that of other cables.

### Advantageous Effects of the Invention

According to the present invention, it is possible to provide a wire harness that can suppress the increase in mold costs and thereby reduce manufacturing costs, even when the connection targets and arrangement of multiple cables vary significantly.

### BRIEF DESCRIPTION OF DRAWINGS

FIG. 1A is an exterior view showing an in-vehicle wire harness according to the first embodiment of the present invention.

FIG. 1B is a cross-sectional view of the wire harness.

FIGS. 2A, 2B, and 2C are cross-sectional views along lines A-A, B-B, and C-C, respectively, in FIG. 1A.

FIG. 3A is a perspective view showing a mounting member and a harness body.

FIG. 3B is a perspective view showing the mounting member mounted on a resin molded member.

FIG. 3C is a perspective view showing a first cable held in a holding portion of the mounting member.

FIG. 4 is a four-view drawing of a harness body.

FIG. 5 is a four-view drawing of the mounting member.

FIGS. 6A and 6B are explanatory drawings showing a mold for forming the resin molded member to constitute the harness body, together with a plurality of harness bodies having the formed resin molded members.

FIG. 7 is an explanatory view showing a mold in a comparative example and two harness bodies having resin molded members formed by this mold.

FIG. 8 is an explanatory view showing an example of use where the wire harness is mounted on a vehicle.

FIGS. 9A and 9B are perspective views showing configuration examples of multiple mounting members having different holding portion shapes.

FIG. 10A to 10C are perspective views showing a mounting member according to a modified example of the first embodiment, together with the harness body with which the mounting member is combined.

FIG. 11A is a perspective view showing a mounting member according to the second embodiment, and a harness body having a resin molded member to which the mounting member is mounted in a swingable manner.

FIG. 11B is a perspective view showing the mounting member attached to the resin molded member.

FIG. 11C is a perspective view showing a first cable held in the holding portion of the mounting member.

FIG. 12A is an explanatory diagram showing a state where a opposing surface of the mounting member relative to the resin molded member and a opposing surface of the resin molded member relative to the mounting member are parallel.

FIG. 12B is an explanatory diagram showing a state where the mounting member has swung relative to the resin molded member.

FIG. 13A is a perspective view showing a mounting member according to a modified example where the shape of the holding portion of the mounting member is changed.

FIG. 13B is a structural diagram showing the shape of a holding groove in the holding portion that holds the first cable in the mounting member shown in FIG. 13A.

FIG. 14A is a perspective view showing the harness body having the mounting member according to the third embodiment and the resin molded member to which the mounting member is mounted in a swingable manner.

FIG. 14B is a perspective view showing the state where the mounting member is mounted on the resin molded member.

FIG. 14C is a perspective view showing the state where the first cable is held in the holding portion of the mounting member.

FIG. 15A is an explanatory view showing a state where the opposing surface of the mounting member in the third embodiment relative to the resin molded member and the opposing surface of the resin molded member relative to the mounting member are parallel. FIG. 15B is an explanatory view showing

FIG. 16 is a four-view of the mounting member according to the fourth embodiment.

FIGS. 17A and 17B are side views showing the mounting member installed on the resin molded member of the harness body according to the fourth embodiment.

### DETAILED DESCRIPTION OF THE INVENTION

### [First Embodiment]

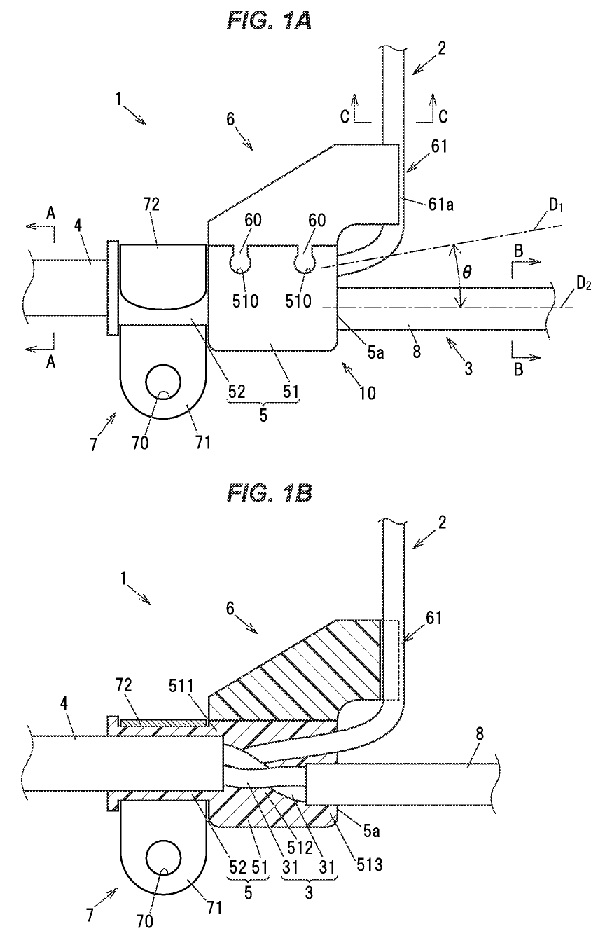

FIG. 1A is an exterior view showing an in-vehicle wire harness 1 according to the first embodiment of the present invention. FIG. 1B is a cross-sectional view of the wire harness 1. The wire harness 1 comprises a first cable 2 and a second cable 3 as multiple cables, connecting an in-vehicle device located under the vehicle springs and a control device on the vehicle body side via the first cable 2 and the second cable 3.

Furthermore, the wire harness 1 further comprises a sheath 4 collectively covering a portion of the longitudinal direction of the first cable 2 and the second cable 3, a resin molded member 5 provided at an end of the sheath 4, a mounting member 6 mounted on the resin molded member 5, a metal bracket 7 fixed to the resin molded member 5, and a tube 8 having one end covered by the resin molded member 5. The tube 8 may be, for example, a hollow tubular member and may have a gap between itself and the second cable 3 outside the resin molded member 5. Alternatively, the tube 8 may be an adhesive-coated heat-shrinkable tube with adhesive applied to its inner surface and may be adhesively fixed so as to have no gap between itself and the second cable 3 outside the resin molded member 5.

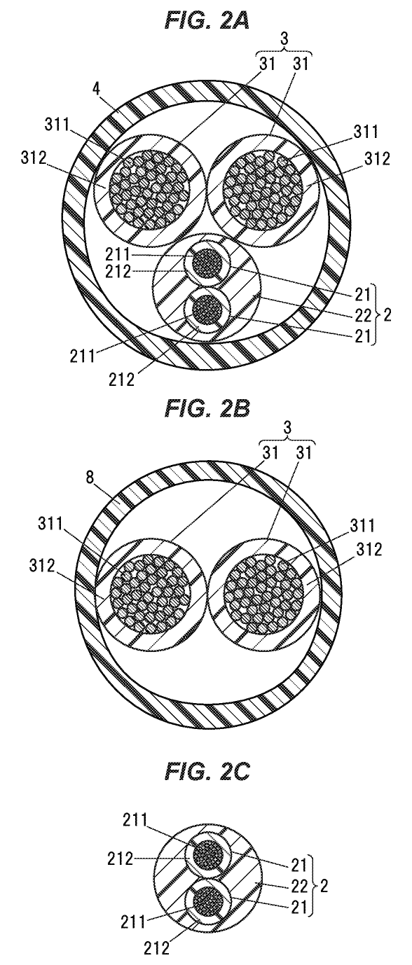

FIGS. 2A, 2B, and 2C are cross-sectional views along lines A-A, B-B, and C-C, respectively, in FIG. 1A. The sheath 4 collectively covers the first cable 2 and the second cable 3. The first cable 2 and the second cable 3 are twisted together inside the sheath 4 and are led out from the end of the sheath 4 within the resin molded member 5. FIG. 1B shows cross-sections of the resin molded member 5 and the mounting member 6, and also shows the first cable 2 and the second cable 3 inside the resin molded member 5. The sheath 4 may be a hollow tubular structure (hollow configuration) as shown in FIG. 2A, and a filler may be further provided within this hollow portion. Alternatively, the sheath 4 may be a solid tubular structure (solid configuration).

The first cable 2 comprises a pair of twisted insulated wires 21, 21 and an outer sheath 22 covering the pair of insulated wires 21, 21. Each insulated wire 21 comprises a conductor wire 211, which is a strand of multiple wires, for example made of a copper alloy, and an insulator 212 made of a resin, such as polyethylene, covering the conductor wire 211.

The second cable 3 comprises a pair of twisted insulated wires 31, 31. Each insulated wire 31 comprises a conductor wire 311 formed by twisting together multiple strands, for example made of a copper alloy, and an insulator 312 made of a resin such as polyethylene covering the conductor wire 311. The insulated wire 21 of the first cable 2 is formed to be thinner than the insulated wire 31 of the second cable 3. Furthermore, the first cable 2 is formed to be thinner than the insulated wire 31 of the second cable 3. The tube 8 covers a portion of the longitudinal direction of the second cable 3 both inside and outside the resin molded member 5.

The resin molded member 5 is a resin molded body formed to cover respective longitudinal one ends of the sheath 4 and the tube 8, the first cable 2 led out from the sheath 4, and the second cable 3 between the sheath 4 and the tube 8. The resin molded member 5, the sheath 4, the tube 8, and the outer sheath 22 of the first cable 2 are made of the same type of resin. This achieves high compatibility between the sheath 4, the tube 8, the outer sheath 22 of the first cable 2, and the resin molded member 5, thereby enhancing waterproofing. Specifically, the heat generated during molding of the resin molded member 5 causes the sheath 4, the tube 8, and the outer sheath 22 of the first cable 2 to fuse with the resin molded member 5, preventing moisture ingress through gaps between these components. In this embodiment, the resin molded member 5, the sheath 4, the tube 8, and the outer sheath 22 of the first cable 2 are made of urethane resin.

In this embodiment, both the first cable 2 and the second cable 3 are led out from a single exit plane 5a of the resin molded member 5, but the exit direction of the first cable 2 is inclined relative to the exit direction of the second cable 3. As shown in FIG. 1A, when the exit direction of the first cable 2 from the resin molded member 5 is designated as D₁, and the exit direction of the second cable 3 and tube 8 from the resin molded member 5 is designated as D₂, an angle θ formed between D1 and D2 is greater than 0° and less than or equal to 45°. In the example shown in FIG. 1A, the angle θ is 10°.

Because the exit direction D₁ of the first cable 2 is inclined relative to the exit direction D₂ of the second cable 3, resin from the resin molded member 5 can more easily enter the space between the first cable 2 and the second cable 3, more specifically between the first cable 2 and the tube 8 covering the second cable 3, thereby enhancing the waterproofing to prevent moisture from penetrating into the resin molded member 5.

As shown in FIG. 1B, the resin molded member 5 comprises a main body portion 51 having a sheath holding portion 511 that covers the outer periphery of the end of the sheath 4 from which the first cable 2 and the second cable 3 are led out and holds the sheath 4, a cable holding portion 512 that holds the first cable 2 and second cable 3 as they exit the sheath 4, and a tube holding portion 513 that holds the tube 8 by covering the outer periphery of the end of the tube 8, and a bracket fixing portion 52, to which the bracket 7 is fixed, and the bracket fixing portion 52 is integrally formed with the main body portion 51. In this embodiment, the bracket fixing portion 52 is formed in a cylindrical shape. The bracket 7 comprises a flat plate portion 71 with a bolt insertion hole 70 formed therein, and a winding tightening portion 72 wound around the bracket fixing portion 52 of the resin molded member 5. Note that the configuration of the sheath holding portion 511, the cable holding portion 512, and the tube holding portion 513 in the main body portion 51 is the same in other embodiments and modifications described later.

Hereinafter, the resin molded member 5, together with the first cable 2, the second cable 3, the sheath 4, and the tube 8 molded into the resin molded member 5 and integrated therewith, shall be referred to as the harness body 10.

The mounting member 6 is a resin molded body that is injection molded separately from the resin molded member 5. The resin material for the mounting member 6 may be the same urethane resin as the resin molded member 5, but is not limited thereto and may be, for example, nylon. The mounting member 6 has a holding portion 61 that holds the first cable 2 and guides the first cable 2 in a direction different from that of the second cable 3. The second cable 3 is not guided by the mounting member 6 and extends along the exit direction from the resin molded member 5 in the vicinity of the resin molded member 5.

The first cable 2 is thinner than the insulated wire 31 of the second cable 3 and is easier to bend than the second cable 3. Therefore, by holding and guiding the first cable 2 with the holding portion 61, it can be bent with a smaller radius of curvature than the second cable 3, enabling miniaturization of the wire harness 1.

However, depending on the application or function of the wire harness 1, the tube 8 may be held by the holding portion 61 of the mounting member 6 to guide the second cable 3 in a direction different from that of the first cable 2. In this case, the first cable 2 is not guided by the mounting member 6 and extends along the exit direction from the resin molded member 5 in the vicinity of the resin molded member 5.

The holding portion 61 is provided on a portion of the mounting member 6 that protrudes beyond the exit plane 5a of the resin molded member 5, along the exit direction of the first cable 2 and second cable 3 from the exit plane 5a, when the mounting member 6 is mounted on the resin molded member 5. This prevents the curvature of the first cable 2 between the exit plane 5a and the holding portion 61 from becoming excessive. Next, the mounting structure between the resin molded member 5 and the mounting member 6 in this embodiment will be described in detail.

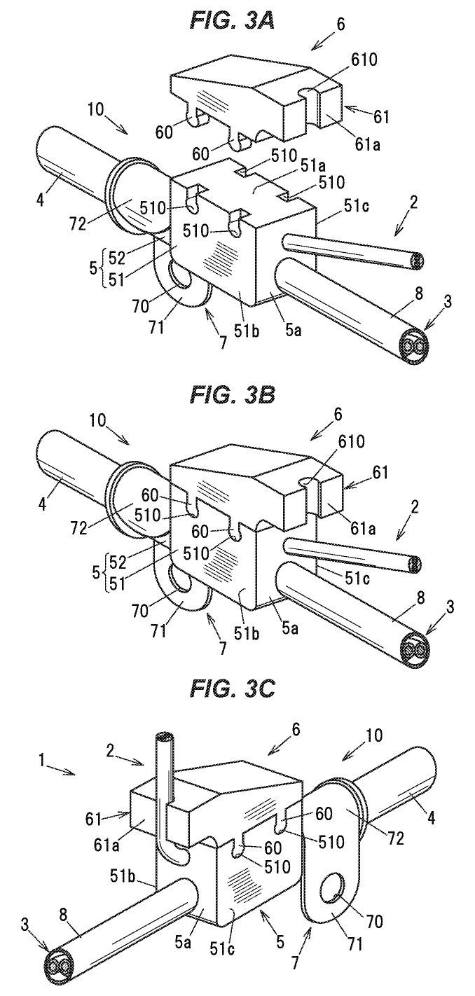

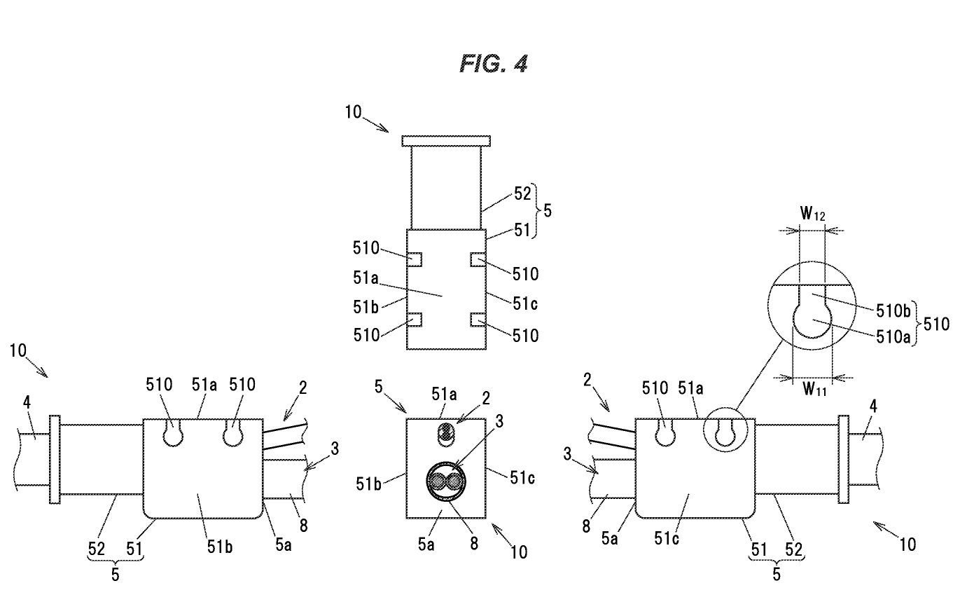

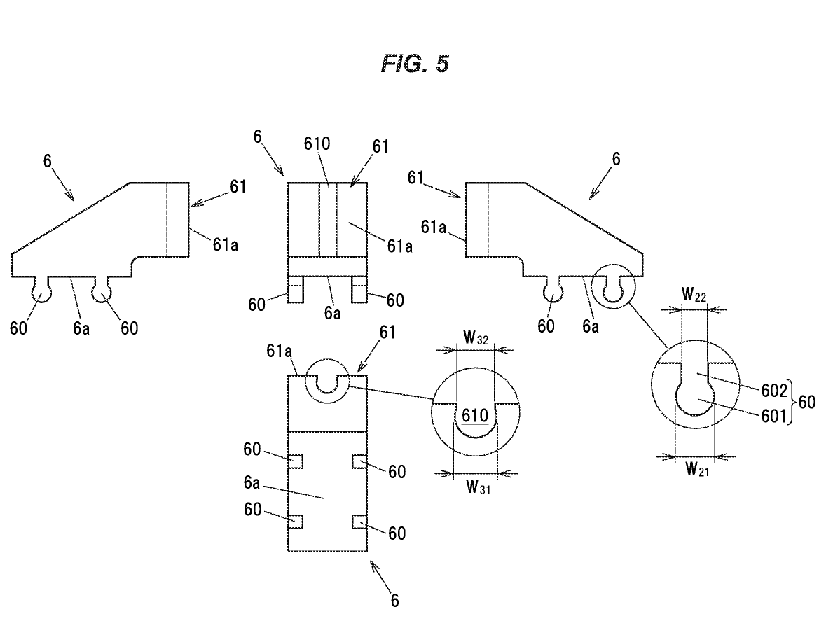

FIG. 3A is a perspective view showing the mounting member 6 and the harness body 10. FIG. 3B is a perspective view showing the mounting member 6 mounted on the resin molded member 5. FIG. 3C is a perspective view showing the state where the first cable 2 is held by the holding portion 61 of the mounting member 6. FIG. 4 is a four-view drawing of the harness body 10. FIG. 5 is a four-view drawing of the mounting member 6. Note that FIG. 3C shows the side view of the resin molded member 5 and the mounting member 6 on the opposite side from those shown in FIGS. 3A and 3B.

The resin molded member 5 and the mounting member 6 are mounted by engaging engagement projections provided on one member with engagement recesses provided on the other member. In this embodiment, the mounting member 6 is mounted to the resin molded member 5 by multiple engagement projections 60 provided on the mounting member 6 engaging with multiple engagement recesses 510 provided on the main body portion 51 of the resin molded member 5.

The main body portion 51 of the resin molded member 5 is cuboid in shape, and a mating surface 51a with the mounting member 6 is a flat rectangular shape. Two engagement recesses 510 are provided on each of the two ends of the short side direction of the mating surface 51a, arranged in the long side direction. Furthermore, two engagement recesses 510 are opened in each of the pair of side surfaces 51b, 51c of the main body portion 51, which are arranged in the short side direction of the mating surface 51a. As enlarged and shown in FIG. 4, the engagement recess 510 comprises an bulge portion 510a and a concave groove portion 510b formed linearly between the bulge portion 510a and the mating surface 51a. A maximum width W₁₁ of a bulge portion 510a in the long side direction of the mating surface 51a is formed to be larger than a width W₁₂ of the concave groove portion 510b in the same direction.

The mounting member 6 has a flat, rectangular mating surface 6a facing the mating surface 51a of the resin molded member 5. Two engagement projections 60 are provided in each of the two ends along the short side direction of the mating surface 6a, arranged in a row along the long side direction. The engagement projections 60 extend perpendicular to the mating surface 6a and comprise a disc-shaped large-diameter portion 601 and a columnar portion 602 between the large-diameter portion 601 and the mating surface 6a. A maximum width W₂₁ of the large-diameter portion 601 in the long-side direction of the mating surface 6a is formed larger than a width W₂₂ of the columnar portion 602 in the same direction. The mounting member 6 possesses four engagement projections 60, thereby providing anti-slip effects in the front-rear, left-right, and up-down directions.

When combining the resin molded member 5 and the mounting member 6, the mating surface 51a of the resin molded member 5 and the mating surface 6a of the mounting member 6 are brought face-to-face. The mating surfaces 51a, 6a are then brought close together, allowing the multiple engagement projections 60 of the mounting member 6 to be respectively engaged with the multiple engagement recesses 510 of the resin molded member 5. When the engagement projections 60 are engaged with the engagement recesses 510, the large-diameter portion 601 of the engagement projection 60 is accommodated within the bulge portion 510a of the engagement recess 510, and the columnar portion 602 of the engagement projection 60 is accommodated within the groove portion 510b of the engagement recess 510.

The maximum width W₂₁ of the large-diameter portion 601 of the engagement projection 60 corresponds to the maximum width W₁₁ of the bulge portion 510a of the engagement recess 510. The width W₂₂ of the columnar portion 602 of the engagement projection 60 corresponds to the width W₁₂ of the groove portion 510b of the engagement recess 510. Furthermore, the maximum width W₂₁ of the large-diameter portion 601 of the engagement projection 60 is larger than the width W₁₂ of the concave groove portion 510b of the engagement recess 510. This prevents the engagement projection 60 from slipping out of the engagement recess 510, ensuring the mounting member 6 does not detach from the resin molded member 5. When the large-diameter portion 601 passes through the concave groove portion 510b, the main body portion 51 of the resin molded member 5 and the engagement projection 60 of the mounting member 6 undergo elastic deformation.

A holding groove 610 is formed in the holding portion 61 of the mounting member 6. This groove extends in a direction parallel to the exit plane 5a of the resin molded member 5 and perpendicular to the mating surface 6a of the mounting member 6. The holding groove 610 has a C-shaped profile when viewed along its extension direction and opens at a tip surface 61a of the holding portion 61. In this embodiment, the tip surface 61a of the holding portion 61 is a plane parallel to the exit plane 5a of the resin molded member 5.

When holding the first cable 2 in the holding portion 61, the first cable 2 is pushed into the holding groove 610 through the opening of the holding groove 610 at the tip surface 61a. As shown in FIG. 5, a maximum width W₃₁ of the holding groove 610 in the direction parallel to the tip surface 61a is wider than a minimum width W₃₂ of the portion through which the first cable 2 passes when holding the first cable 2 in the holding portion 61. Furthermore, the minimum width W₃₂ is narrower than the outer diameter of the first cable 2. This prevents the first cable 2 from slipping out of the holding groove 610.

When assembling the wire harness 1, the resin molded member 5 is formed using a mold to constitute the harness body 10. Subsequently, a pre-formed mounting member 6 is mounted onto the resin molded member 5. Afterwards, the first cable 2, which is led out from the resin molded member 5, is held in the holding portion 61 of the mounting member 6.

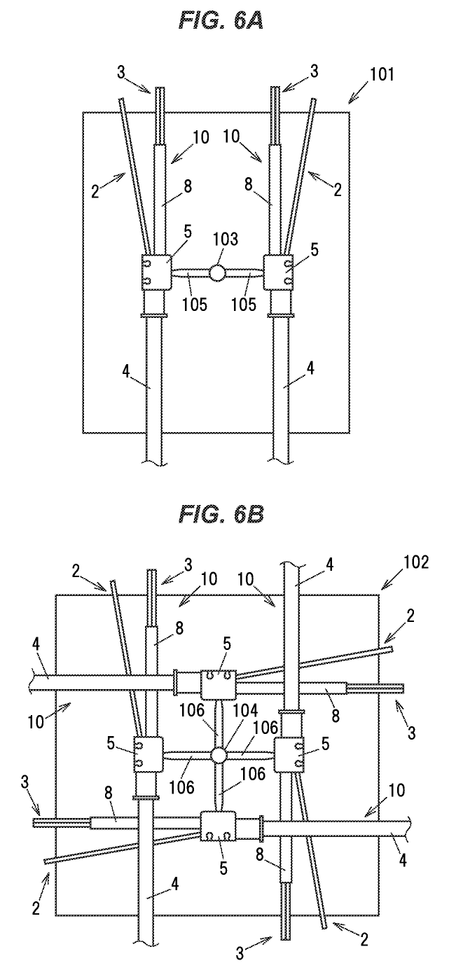

FIGS. 6A and 6B are explanatory views showing the molds (lower molds) 101, 102 for forming the resin molded member 5 to constitute the harness body 10, together with a plurality of harness bodies 10 having the formed resin molded member 5. Since the resin molded member 5 has multiple engagement recesses 510 open on the side surfaces 51b, 51c of the main body portion 51, it can be molded using upper and lower dies without employing a slide mold. FIGS. 6A and 6B also show sprues 103, 104 and runners 105, 106 formed by the flow of resin. The molten resin is injected into the cavity from the portion that becomes the mating surface 51a in the resin molded member 5 to be formed.

In the mold 101 shown in FIG. 6A, the resin molded members 5 of two harness bodies 10 are formed. The mold 101 positions the first cable 2, second cable 3, sheath 4, and tube 8 such that the respective sheaths 4 of the two harness bodies 10 are parallel to each other.

The mold 102 shown in FIG. 6B forms the resin molded members 5 for four harness bodies 10. In the mold 102, the first cable 2, second cable 3, sheath 4, and tube 8 are arranged so that the sheath 4 and tube 8 of each of the four harness bodies 10 cross each other. At the points where the first cable 2, second cable 3, sheath 4, and tube 8 cross, these components are held by either the upper or lower mold.

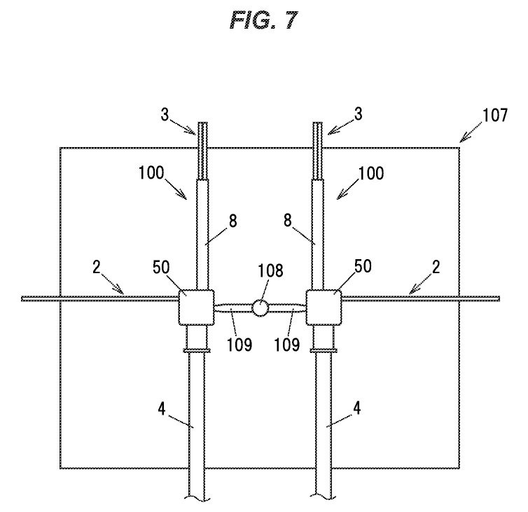

FIG. 7 is an explanatory diagram showing a mold (lower mold) 107 pertaining to a comparative example, and two harness bodies 100 having resin molded members 50 formed by this mold 107. FIG. 7 also shows a sprue 108 and a runner 109 formed by the flow of resin for molding the resin molded members 50. The harness body 100, like the harness body 10 of the present embodiment, includes a first cable 2, a second cable 3, a sheath 4, and a tube 8. However, the exit direction of the first cable 2 from the resin molded member 50 differs from that of the harness body 10, with the first cable 2 exiting at a right angle to the second cable 3.

Comparing the mold 101 shown in FIG. 6A with the mold 107 in the comparative example, the mold 101 allows for a narrower width in the direction perpendicular to the second cable 3, sheath 4, and tube 8. This is because the first cable 2 and second cable 3 are guided out from the exit plane 5a of the resin molded member 5. Consequently, mold 101 can be made smaller than the mold 107 in the comparative example, reducing mold costs. Furthermore, the mold 102 shown in FIG. 6B can simultaneously mold the resin molded members 5 of four harness bodies 10, improving production efficiency.

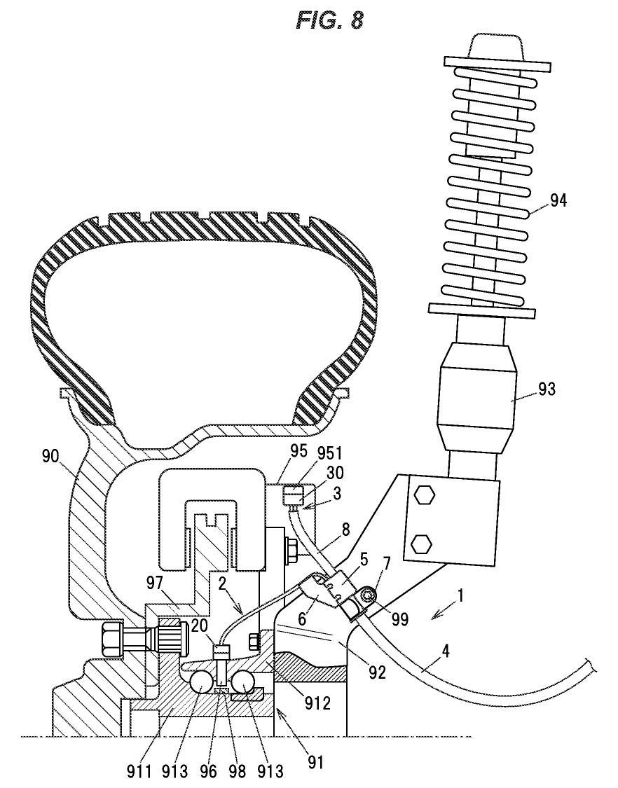

FIG. 8 is an explanatory diagram showing an example of using the wire harness 1 of this embodiment installed in a vehicle. FIG. 8 shows a wheel 90, a hub unit 91 rotatably supporting the wheel 90, a knuckle 92 of a suspension device to which the hub unit 91 is attached, a variable damping force damper 93 connected to the knuckle 92, a suspension spring 94, an electric parking brake device 95, a wheel speed sensor 96 detecting the rotational speed of the wheel 90, and a brake disc 97 rotating with the wheel 90. The tube 8 protects the second cable 3 from damage caused by flying stones, etc.

The hub unit 91 comprises a hub ring 911 rotating integrally with the wheel 90, an outer ring 912 fixed to the knuckle 92, and a plurality of rolling elements 913 positioned between the hub ring 911 and the outer ring 912. An annular magnetic encoder 98, having multiple magnetic poles along its circumference, is fixed on the hub ring 911 facing a wheel speed sensor 96. The wheel speed sensor 96 is fixed to the outer ring 912 and detects the rotational speed of the wheel 90 based on the rotation of the magnetic encoder 98.

The bracket 7 of the wire harness 1 is fastened to the knuckle 92 by bolts 99, thereby securing the resin molded member 5 to the knuckle 92. A connector 20 for connection to the wheel speed sensor 96 is attached to the tip of the first cable 2. A connector 30 is attached to the tip of the second cable 3 for connection to a connector 951 on the electric parking brake device 95 side. That is, in this embodiment, the first cable 2 is a wheel speed signal cable connected to the wheel speed sensor 96 to transmit the wheel speed detection signal.

As shown in FIG. 8, although the positions of the wheel speed sensor 96 and the electric parking brake device 95, as seen from the resin molded member 5, are significantly different, the first cable 2 is guided toward the position of the wheel speed sensor 96 by the mounting member 6. This allows the first cable 2 to connect to the wheel speed sensor 96 without significantly bending at the tip end relative to the mounting member 6. This prevents the outer sheath 22 of the first cable 2 from wearing due to contact with, for example, the outer ring 912 of the hub unit 91 or the brake disc 97.

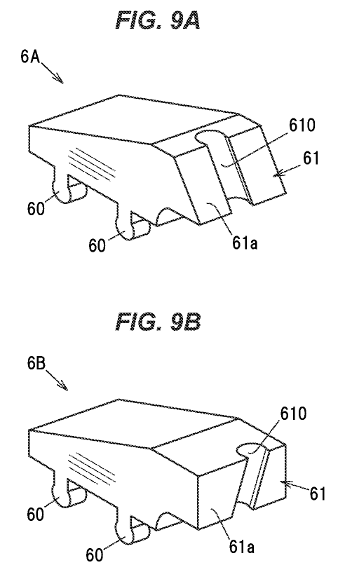

FIGS. 9A and 9B are perspective views showing configuration examples of mounting members 6A, 6B, which have different shapes of the holding portion 61. The mounting members 6A, 6B, like the above mounting member 6, have multiple engagement projections 60 and are mounted on the resin molded member 5. The angle of the holding grooves 610 in the mounting members 6A, 6B differs from that in the above mounting member 6. When using the mounting members 6A or 6B, the first cable 2 can be guided in a different direction compared to when using the mounting member 6. This allows the first cable 2 to be guided toward its connection target without changing the shape of the resin molded member 5, even if the vehicle configuration changes. In other words, the harness body 10 can be shared across many vehicle models without changing its configuration.

Furthermore, since the mounting members 6, 6A, and 6B are smaller than the harness body 10, the mold for forming the mounting members 6, 6A, and 6B can be smaller than, for example, the mold 101 shown in FIG. 6A. Moreover, it is easily possible to configure the mold for producing multiple pieces and to simultaneously form a large number of mounting members 6, 6A, and 6B in a single injection molding operation.

### (Effect of the First Embodiment)

According to the first embodiment described above, since the resin molded member 5 and the mounting member 6 are separate parts, even if the vehicle configuration changes, it is possible to respond simply by changing the shape of the mounting member 6. This enables standardization of the resin molded member 5 and the harness body 10 equipped with it, reduces the mold cost for forming the resin molded member 5, and allows for a reduction in manufacturing costs.

### [Modified Example of the First Embodiment]

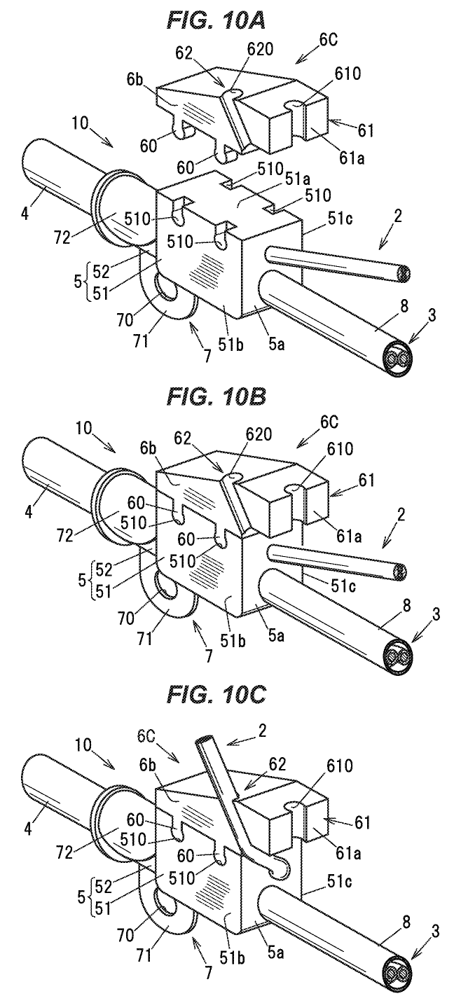

FIGS. 10A to 10C are perspective views showing the mounting member 6C according to a modified example of the first embodiment, together with the harness body 10 with which the mounting member 6C is assembled. The first embodiment described above pertained to the mounting member 6 having the single holding portion 61. However, the mounting member 6C of this modified example is provided with an additional holding portion 62, in addition to the holding portion 61 similar to that of mounting member 6. FIG. 10B shows the mounting member 6C mounted on the resin molded member 5, and FIG. 10C shows the first cable 2 held in the holding portion 62 of the mounting member 6C.

A holding groove 620 for holding the first cable 2 is formed in the holding portion 62 of the mounting member 6C. The holding groove 620 extends in a direction inclined relative to the exit plane 5a of the resin molded member 5 and opens onto the side surface 6b of the mounting member 6C. When the first cable 2 is held in the holding portion 62 of the mounting member 6C, the first cable 2 is guided in a direction different from that when it is held in the holding portion 61 of the mounting member 6C. Thus, the mounting member 6C is provided with multiple holding portions 61, 62, and the guiding directions of the first cable 2 by these multiple holding portions 61, 62 are different from each other.

According to this modified example, in addition to the effects of the first embodiment, since the mounting member 6C has multiple holding portions 61, 62, the first cable 2 can be guided in multiple different directions, for example, according to the vehicle configuration. Specifically, the direction in which the first cable 2 is guided can be changed depending on whether it is held by the holding portion 61 or the holding portion 62 of the mounting member 6C. This enables the mounting member 6C to be shared across multiple vehicle models with different configurations, thereby suppressing increases in mold costs for forming the mounting member 6C.

Furthermore, the harness body 10 may be configured to include a third cable in addition to the first cable 2 and the second cable 3, guiding the first cable 2 via the holding portion 61 of the mounting member 6C and guiding the third cable via the holding portion 62. In this case, the third cable may connect, for example, to a redundant wheel speed sensor or a wheel vertical acceleration sensor detecting wheel vertical movement. Alternatively, the third cable may connect to the variable damping force damper 93 described above.

### [Second Embodiment]

Next, the second embodiment of the present invention will be described. The first embodiment described how the mounting member 6 is fixed to the resin molded member 5 by engaging multiple engagement projections 60 of the mounting member 6 with multiple engagement recesses 510 of the resin molded member 5. In contrast, the second embodiment allows the mounting member to be swingably mounted relative to the resin molded member.

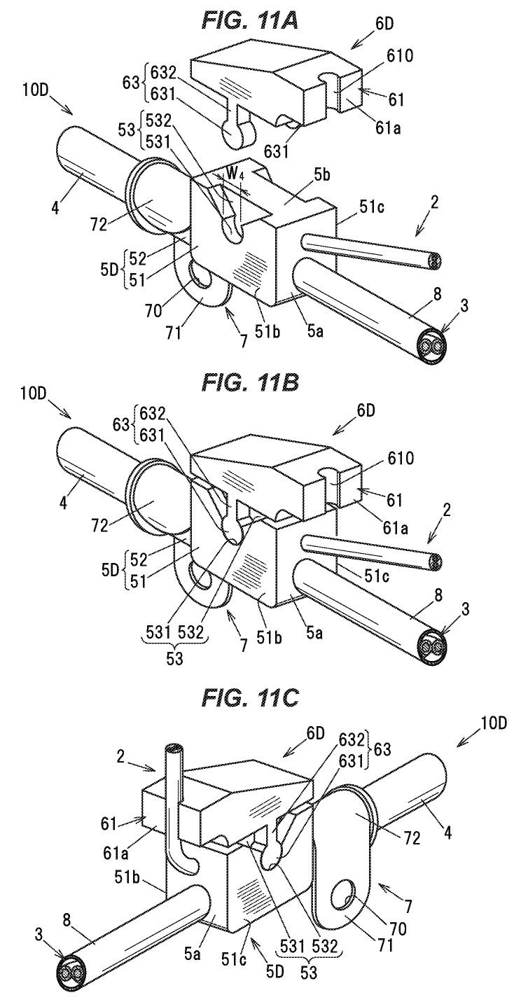

FIG. 11A is a perspective view showing a harness body 10D according to this embodiment, having a mounting member 6D and a resin molded member 5D to which the mounting member 6D is mounted in a swingable manner. FIG. 11B is a perspective view showing the state where the mounting member 6D is mounted on the resin molded member 5D. FIG. 11C is a perspective view showing the state where the first cable 2 is held by the holding portion 61 of the mounting member 6D. FIG. 11C shows the side view of the resin molded member 5D and the mounting member 6D on the opposite side from those shown in FIGS. 11A and 11B.

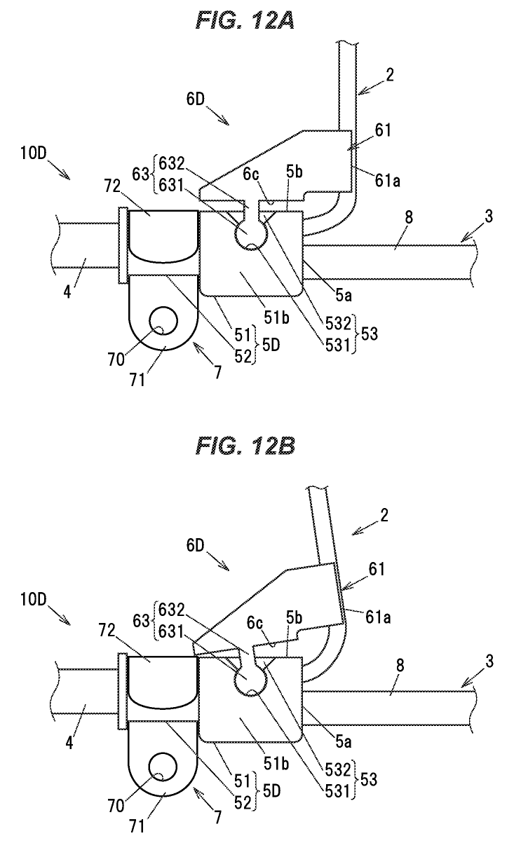

FIG. 12A is an explanatory view showing a state where the opposing surface 6c of the mounting member 6D relative to the resin molded member 5D and the opposing surface 5b of the resin molded member 5D relative to the mounting member 6D are parallel. FIG. 12B is an explanatory view showing a state where the mounting member 6D has swung relative to the resin molded member 5D. As shown in FIG. 12A, when the respective opposing surfaces 6c and 5b of the mounting member 6D and the resin molded member 5D are parallel, a space is formed between these opposing surfaces 6c and 5b. The opposing surfaces 6c and 5b are rectangular in shape, with the direction along the longitudinal direction of the sheath 4 and tube 8 being the long side direction.

The harness body 10D, like the harness body 10 of the first embodiment, comprises a first cable 2, a second cable 3, a sheath 4, and a tube 8. The first cable 2 and the second cable 3 are led out from the sheath 4 inside the resin molded member 5D. The exit direction of the first cable 2 and second cable 3 from the resin molded member 5D is also the same as that of the harness body 10 according to the first embodiment.

The mounting member 6D has a pair of swing arms 63 protruding from the opposing surface 6c of the mounting member 6D toward the resin molded member 5D. The swing arm 63 has a disc-shaped disc portion 631 provided at its tip and a columnar portion 632 between the opposing surface 6c and the disc portion 631. Furthermore, the mounting member 6D has a holding portion 61 similar to that of the mounting member 6 according to the first embodiment.

The resin molded member 5D is provided with a pair of recesses 53. Each recess 53 has an engagement hole 531, into which the disc portion 631 of the swing arm 63 engages, and a notch 532, which accommodates the columnar portion 632 of the swing arm 63. The engagement hole 531 and the notch 532 are interconnected. The width W₄ (see FIG. 11A) of the end portion of the notch 532 side within the engagement hole 531 is narrower than the diameter of the disc portion 631. This prevents the disc portion 631 from slipping out of the engagement hole 531. When mounting the mounting member 6D onto the resin molded member 5D, the main body portion 51 and the disc portion 631 of the resin molded member 5D elastically deform.

A pair of recesses 53 are formed in the resin molded member 5D, with the engagement hole 531 and the notch 532 arranged in a direction perpendicular to the opposing surface 5b of the resin molded member 5D. Furthermore, one recess 53 opens onto one side surface 51b of the main body portion 51 of the resin molded member 5D, and the other recess 53 opens onto the other side surface 51c of the main body portion 51 of the resin molded member 5D.

The mounting member 6D is capable of swinging relative to the resin molded member 5D about the disk portion 631 of the swing arm 63 while holding the first cable 2 in the holding portion 61. Consequently, even when the connection target of the first cable 2 moves relative to the member to which the resin molded member 5D is fixed, the stress on the first cable 2 is relaxed by the swinging of the mounting member 6D.

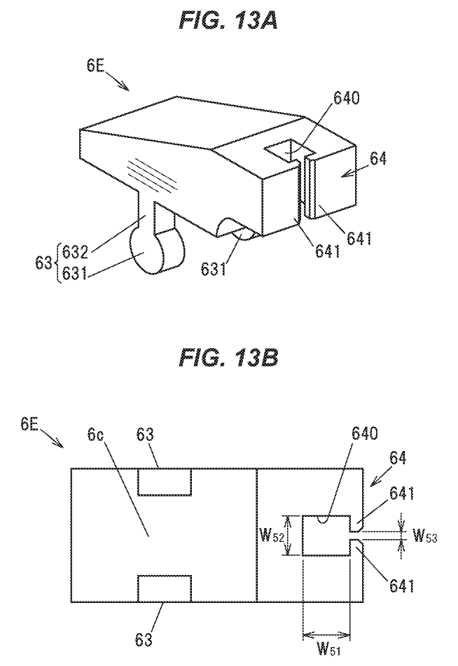

FIG. 13A is a perspective view showing a mounting member 6E, which is a modified example with a modified shape of the holding portion 61 of the mounting member 6D. FIG. 13B is a schematic diagram showing the shape of a holding groove 640 in a holding portion 64 that holds the first cable 2 in a mounting member 6E. The mounting member 6E, like the mounting member 6D, has a pair of swing arms 63. It is mounted on the resin molded member 5D and is capable of swinging relative to the resin molded member 5D.

The mounting member 6E has the holding groove 640 in the holding portion 64 for holding the first cable 2, which is rectangular in shape. A width W₅₁ of the holding groove 640 in the direction along the long side of the opposing surface 6c and a width W₅₂ of the holding groove 640 in the direction along the short side of the opposing surface 6c are formed larger than the outer diameter of the first cable 2. Furthermore, the holding portion 64 of the mounting member 6E includes a pair of wall portions 641 that prevent the first cable 2 from slipping out of the holding groove 640. A width W₅₃ between the pair of wall portions 641 is formed to be narrower than the outer diameter of the first cable 2. When accommodating the first cable 2 into the holding groove 640, the pair of wall portions 641 are elastically deformed to push the first cable 2 into the holding groove 640 from between the pair of wall portions 641.

According to this modified example, since the first cable 2 is accommodated within the holding groove 640 while remaining longitudinally movable relative to the mounting member 6E, stress on the first cable 2 is further relaxed when the mounting member 6E swings relative to the resin molded member 5D.

### [Third Embodiment]

Next, the third embodiment of the present invention will be described. In this embodiment, similar to the second embodiment, the mounting member is swingable relative to the resin molded member, but its mounting structure differs from that of the second embodiment.

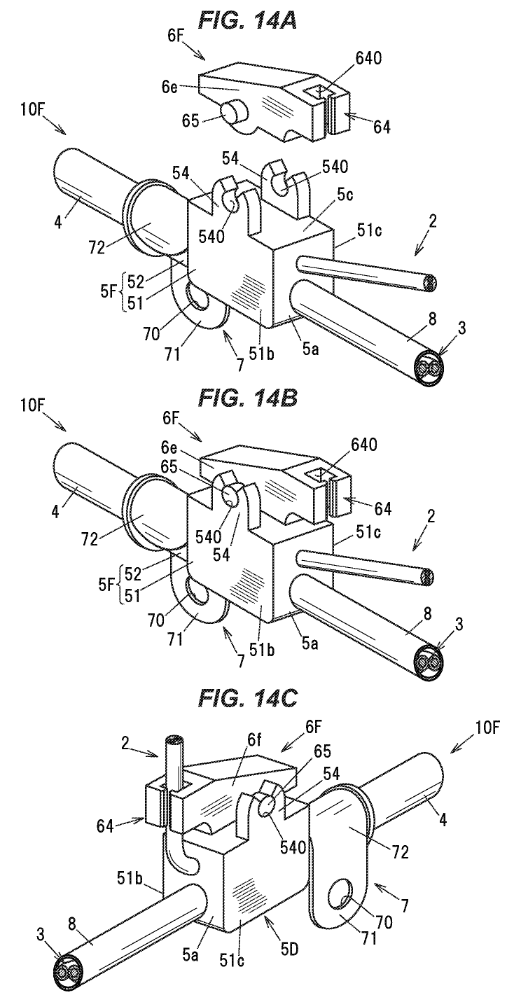

FIG. 14A is a perspective view showing a harness body 10F of this embodiment, having a mounting member 6F and a resin molded member 5F to which the mounting member 6F is mounted in a swingable manner. FIG. 14B is a perspective view showing the state where the mounting member 6F is mounted on the resin molded member 5F. FIG. 14C is a perspective view showing the state where a first cable 2 is held in a holding portion 64 of the mounting member 6F. FIG. 14C shows the side of the resin molded member 5F and the mounting member 6F opposite to that shown in FIGS. 14A and 14B.

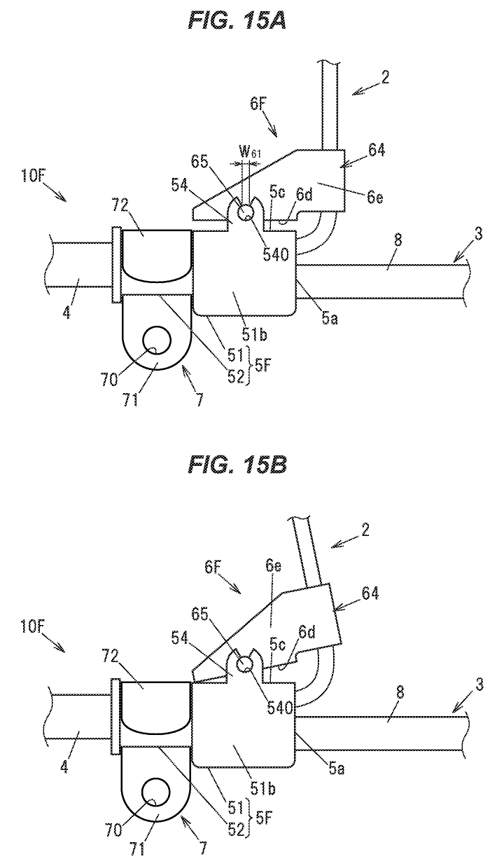

FIG. 15A is an explanatory view showing a state where the opposing surface 6d of the mounting member 6F relative to the resin molded member 5F and the opposing surface 5c of the resin molded member 5F relative to the mounting member 6F are parallel. FIG. 15B is an explanatory view showing a state where the mounting member 6F has swung relative to the resin molded member 5F. When the respective opposing surfaces 6d and 5c of the mounting member 6F and the resin molded member 5F are parallel, a space is formed between these opposing surfaces 6d and 5c. The opposing surfaces 6d and 5c are rectangular in shape, with the direction along the longitudinal direction of the sheath 4 and tube 8 being the long side direction.

The mounting member 6F has a holding portion 64, described with reference to FIGS. 13A and 13B, and a pair of cylindrical shaft portions 65 extending outward from both side surfaces 6e and 6f. The resin molded member 5F has a pair of support projections 54 that protrude from the opposing surface 5c toward the mounting member 6F side and support the pair of shaft portions 65 of the mounting member 6F, respectively. The support projections 54 have holding holes 540 formed therein to retain the shaft portions 65 of the mounting member 6F. The holding holes 540 open in a direction perpendicular to the opposing surface 5c, and their opening width W₆₁ (see FIG. 15A) is narrower than the diameter of the shaft portion 65. When mounting the mounting member 6F onto the resin molded member 5F, the support projections 54 are elastically deformed to expand the opening of the holding holes 540, allowing the shaft portions 65 to be pressed into the holding holes 540.

This third embodiment also achieves effects similar to those of the second embodiment.

### [Fourth Embodiment]

Next, the fourth embodiment of the present invention will be described. In the fourth embodiment, the angle of the mounting member relative to the resin molded member can be adjusted in multiple stages.

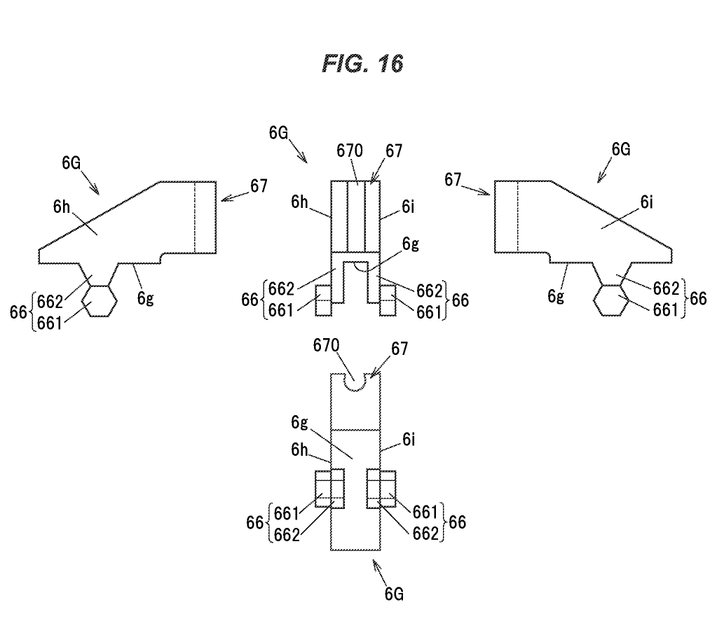

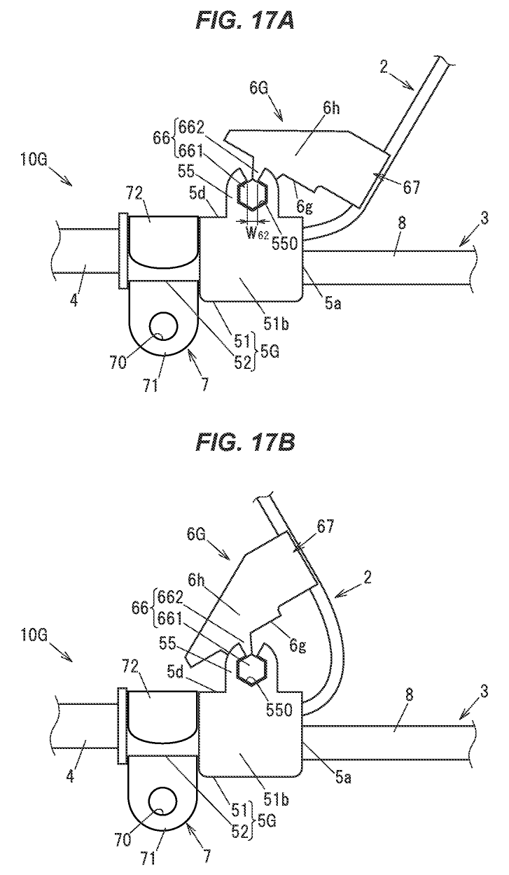

FIG. 16 is a four-view of a mounting member 6G according to this embodiment. FIGS. 17A and 17B are side views showing the mounting member 6G attached to a resin molded member 5G of a harness body 10G. The angle of the mounting member 6G relative to the resin molded member 5G differs between the state shown in FIG. 17A and the state shown in FIG. 17B.

As shown in FIG. 16, the mounting member 6G has a pair of arms 66 extending from an opposing surface 6g of the mounting member 6G toward the resin molded member 5G. The arm 66 comprises a polygonal supported portion 661 formed at its tip and a columnar portion 662 extending between the opposing surface 6g and the supported portion 661. The columnar portions 662 of the pair of arms 66 extend along the side surfaces 6h, 6i of the mounting member 6G in a direction perpendicular to the opposing surface 6g. The supported portion 661 of one arm 66 is provided to protrude from one side surface 6h of the mounting member 6G, while the supported portion 661 of the other arm 66 is provided to protrude from the other side surface 6i of the mounting member 6G. In this embodiment, the supported portion 661, as viewed from a direction perpendicular to the side surfaces 6h, 6i, has a hexagonal shape. However, the shape of the supported portion 661 need only be non-circular and may be polygonal (where n is a natural number of 3 or greater) or elliptical.

Furthermore, the mounting member 6D has a holding portion 67 similar to the holding portion of the mounting member 6 according to the first embodiment. A holding groove 670 for accommodating the second cable 3 is formed in the holding portion 67.

The resin molded member 5G has a pair of support projections 55 that protrude from the opposing surface 5d, which faces the opposing surface 6g of the mounting member 6G, toward the mounting member 6G side. These support projections 55 support the respective supported portions 661 of the pair of arms 66 of the mounting member 6G. FIGS. 17A and 17B show one of the pair of support projections 55. The support projection 55 has a holding hole 550 formed with a shape corresponding to the supported portion 661. The holding hole 550 opens in a direction perpendicular to the opposing surface 5d, and its opening width W₆₂ (see FIG. 17A) is formed smaller than the size of the supported portion 661. This prevents the supported portion 661 from slipping out of the holding hole 550.

When mounting the mounting member 6G onto the resin molded member 5G, the support projections 55 may be elastically deformed to expand the opening of the holding hole 550. Alternatively, the pair of arms 66 may be elastically deformed to bring the supported portions 661 of the pair of arms 66 closer together, allowing the supported portion 661 to be fitted into the holding hole 550 from between the pair of support projections 55. Forming the resin molded member 5G and the mounting member 6G from urethane facilitates such elastic deformation.

As shown in FIGS. 17A and 17B, in this embodiment, the mounting member 6G can be fixed to the resin molded member 5G at multiple different angles. The guide direction of the second cable 3 by the mounting member 6G is variable according to this angle. That is, the guide direction of the second cable 3 can be selected based on the angle of the mounting member 6G relative to the resin molded member 5G. This enables, for example, the shared use of the resin molded member 5G and the mounting member 6G across multiple vehicle models with differing vehicle configurations, thereby suppressing increases in mold costs for forming the resin molded member 5G and the mounting member 6G.

### (Summary of Embodiments)

Next, the technical concept understood from the above-described embodiments is described using reference numerals from the embodiments. However, the reference numerals in the following description do not limit the components in the claims to the specific parts shown in the embodiments.

According to the first feature, a wire harness 1 including a plurality of cables 2, 3; a sheath 4 collectively covering a portion in a longitudinal direction of the plurality of cables 2, 3; a resin molded member 5, 5D, 5F integrally having a sheath holding portion 511 covering an outer periphery of an end of the sheath 4 from which the plurality of cables 2, 3 are led out and holding the sheath 4, and a cable holding portion 512 holding the plurality of cables 2, 3 led out from the sheath 4; and a mounting member 6, 6A, 6B, 6C, 6D, 6E, 6F mounted on the resin molded member 50, wherein the mounting member 6, 6A, 6B, 6C, 6D, 6E, 6F has a holding portion 61, 62, 64 for holding at least one cable 2 of the plurality of cables 2, 3, and guides the at least one cable 2 in a direction different from that of the other cable 3.

According to the second feature, in the wire harness 1 as described in the first feature, the resin molded member 5 and the mounting members 6, 6A, 6B, 6C are mounted by an engagement projection 60 provided on one member 6, 6A, 6B, 6C engaging with an engagement recess 510 provided on the other member 5.

According to the third feature, in the wire harness 1 as described in the first feature, a plurality of holding portions 61, 62 are provided on the mounting member 6, 6A, 6B, 6C, and guide directions of the at least one cable 2 by these plural holding portions 61, 62 are different from each other.

According to the fourth feature, in the wire harness 1 as described in the first feature, the mounting members 6D, 6E, 6F are swingable relative to the resin molded member 5D, 5F.

According to the fifth feature, in the wire harness 1 as described in the first feature, an angle of the mounting member 6G relative to the resin molded member 5G is adjustable in multiple stages.

According to the sixth feature, in the wire harness as described in any one of the first to fifth features, the plurality of cables 2, 3 includes a first cable 2 guided by the mounting member 6, 6A, 6B, 6C, 6D, 6E, 6F, 6G and a second cable 3 not guided by the mounting member 6, 6A, 6B, 6C, 6D, 6E, 6F, 6G, 6G, wherein an angle formed between an exit direction D₁ of the first cable 2 from the resin molded member 5, 5D, 5F, 5G and an exit direction D₂ of the second cable 3 is greater than 0° and less than or equal to 45°.

According to the seventh feature, in the wire harness 1 as described in the sixth feature, the first cable 2 is a wheel speed signal cable connected to a wheel speed sensor 96 that detects a rotational speed of a wheel 90.

The above describes embodiments of the present invention; however, these embodiments do not limit the invention claimed in the claims. It should also be noted that not all combinations of features described in the embodiments are necessarily essential to solve the technical problems of the invention. Furthermore, the present invention may be appropriately modified and implemented within the scope of its spirit without departing from its essence. For example, while the first embodiment described above pertains to a wire harness 1 mounted in a vehicle, the wire harness 1 is not limited to vehicle use and can be employed in various industrial machinery, etc. Furthermore, depending on the installation location or application of the wire harness 1, the tube 8 may be omitted, and various known configurations may be applied to the structure of the first cable 2 and second cable 3.

1. A wire harness, comprising:
a plurality of cables;
a sheath collectively covering a portion in a longitudinal direction of the plurality of cables;
a resin molded member integrally having a sheath holding portion covering an outer periphery of an end of the sheath from which the plurality of cables are led out and holding the sheath, and a cable holding portion holding the plurality of cables led out from the sheath; and
a mounting member mounted on the resin molded member,
wherein the mounting member has a holding portion for holding at least one cable of the plurality of cables and guides the at least one cable in a direction different from that of other cables.

2. The wire harness, according to claim 1, wherein the resin molded member and the mounting members are mounted by an engagement projection provided on one member engaging with an engagement recess provided on another member.

3. The wire harness, according to claim 1, wherein a plurality of holding portions are provided on the mounting member, and guide directions of the at least one cable by these plural holding portions are different from each other.

4. The wire harness, according to claim 1, wherein the mounting members are swingable relative to the resin molded member.

5. The wire harness, according to claim 1, wherein an angle of the mounting member relative to the resin molded member is adjustable in multiple stages.

6. The wire harness, according to claim 1, wherein the plurality of cables includes a first cable guided by the mounting member, and a second cable not guided by the mounting member,
wherein an angle formed between an exit direction of the first cable from the resin molded member and an exit direction of the second cable is greater than 0° and less than or equal to 45°.

7. The wire harness, according to claim 6, wherein the first cable is a wheel speed signal cable connected to a wheel speed sensor that detects a rotational speed of a wheel.
